(19) United States
(12) Patent Application Publication
(10) Pub. No.: US 2026/0116322 A1
(43) Pub. Date: Apr. 30, 2026

(54) POWER PRODUCING TRAILER

(71) Applicant: Joseph Stiardly Innocent, New Windsor, NY (US)

(72) Inventor: Joseph Stiardly Innocent, New Windsor, NY (US)

(21) Appl. No.: 19/082,981

(22) Filed: Mar. 18, 2025

Related U.S. Application Data
(63) Continuation-in-part of application No. 29/970,488, filed on Oct. 29, 2024, now Pat. No. D1104866.

(51) Int. Cl. B60R 16/033; B60L 53/51; B62D 63/08

(52) U.S. Cl. CPC B60R 16/033; B60L 53/51; B62D 63/08; B60Y 2400/112

(57) ABSTRACT

A power producing trailer is disclosed, featuring multiple solar panels pivotably connected to the sides, top, and front, which generate electricity to charge an electric vehicle (EV). The solar panels are connected to a solar inverter, an EV charger, and a battery system for energy storage. The trailer includes a ramp for loading an EV, which can be charged while parked inside. This portable solution provides renewable energy for uses such as emergency relief, mobile workstations, events, and off-grid camping, and can function as a backup power source.

### CROSS-REFERENCE TO RELATED APPLICATION

This application claims the benefit of, and is a continuation-in-part application of, U.S. Design application Ser. No. 29/970,488, filed Oct. 29, 2024, the contents of which are herein incorporated by reference.

### BACKGROUND OF THE INVENTION

Electric cars (EVs) are more popular than ever due to a combination of technological advancements, government incentives, and environmental awareness. They are more popular for many reasons, including:
Increased Range & Better Batteries—Modern EVs offer longer ranges on a single charge, thanks to advancements in battery technology. Some models now exceed 300-400 miles per charge, eliminating range anxiety for many drivers.
More Affordable Options—EVs are no longer just for luxury buyers. Automakers like Tesla, Ford, Hyundai, and Volkswagen are producing more affordable electric models, making them accessible to a broader audience.
Lower Operating Costs—EVs generally have fewer moving parts than traditional gas-powered cars, resulting in lower maintenance costs.
Environmental Awareness—Many EVs now boast zero tailpipe emissions, making them a cleaner alternative to gas-powered vehicles.
More Models & Variety—Automakers are rolling out a wide range of EVs, including sedans, SUVs, trucks, and even high-performance sports cars. This diversity attracts more buyers who may have previously been hesitant due to limited choices.
Advancements in Autonomous & Smart Features—Many EVs come equipped with cutting-edge technology, such as self-driving capabilities, AI-powered driver assistance, and seamless integration with smart home systems, making them appealing to tech-savvy consumers.

As a result of these factors, EV sales have been growing rapidly and may one day overtake traditional gasoline-powered vehicles.

A lack of suitable and convenient charging infrastructure, however, can significantly impact the decision to buy an electric vehicle, because, for example:
Range Anxiety—One of the biggest concerns for potential EV buyers is whether they will have enough charge to complete their trips. If charging stations are scarce, drivers may worry about running out of power, especially on long journeys.
Limited Home Charging Options—Not everyone has access to a personal charging station. Apartment dwellers or those without a garage may struggle to find convenient places to charge their vehicle, making EV ownership less practical.
Longer Charging Times—Unlike gas stations, which can refuel a car in minutes, EV charging takes longer. If fast chargers are not widely available, drivers may have to wait longer at the few public stations, making the experience less convenient.
Regional Disparities—Some areas, especially rural regions, have very few charging stations. This makes EVs less appealing to people who live in or frequently travel to such locations, as they may have difficulty finding a place to recharge.
Uncertainty About Future Infrastructure Growth—Some consumers may hesitate to invest in an EV if they are unsure whether charging infrastructure will expand quickly enough to meet demand.

Because of these concerns, a weak charging network can impact EV adoption.

### SUMMARY OF THE INVENTION

In one aspect of the present invention, there is disclosed a trailer that includes solar panels and related equipment in order to generate electricity that can be used to charge an electric vehicle.

In another aspect, the present invention discloses a power producing trailer equipped with multiple solar panels pivotably connected to the sides, top, and front. These panels are electrically connected to a solar inverter, an electric vehicle (EV) charger, and a battery system to generate and store energy for charging an EV. The trailer includes a ramp for loading an EV, which can be charged while parked inside. The solar panels can be adjusted for optimal sunlight absorption, and the trailer can function as a portable backup power source. Additional features may include a camera system, heat pump, and car hub motor. Constructed from lightweight, durable materials, the trailer is designed for enhanced portability and durability, making it suitable for applications such as emergency relief, mobile workstations, events, and off-grid camping.

These and other features, aspects and advantages of the present invention will become better understood with reference to the following drawings, description and claims.

### BRIEF DESCRIPTION OF THE DRAWINGS

FIG. 1 is a perspective view of a power producing trailer in accordance with a preferred embodiment of the present invention;

FIG. 2 is a top view of the power producing trailer of FIG. 1;

FIG. 3 is a section view taken along line 3-3 in FIG. 2;

FIG. 4 is a perspective view of a power producing trailer in accordance with a preferred embodiment of the present invention;

FIG. 5 is a top view of the power producing trailer of FIG. 4;

FIG. 6 is a bottom view of the power producing trailer of FIG. 4;

FIG. 7 is a front view of the power producing trailer of FIG. 4;

FIG. 8 is a rear view of the power producing trailer of FIG. 4; and

FIG. 9 is a side view of the power producing trailer of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a trailer that comprises one or more solar panels and related equipment that is configured to generate electrical power that can be used to charge an electric vehicle.

As stated above, the lack of suitable and convenient electric vehicle charging infrastructure can seriously impact people's desire to buy electric cars. The invention claimed here solves these and other problems with conventional systems and methods.

Right now, there is no product or trailer that is out there that can be used to generate power during the day and can be used to charge an electric car at night, all while the car is parked inside the trailer.

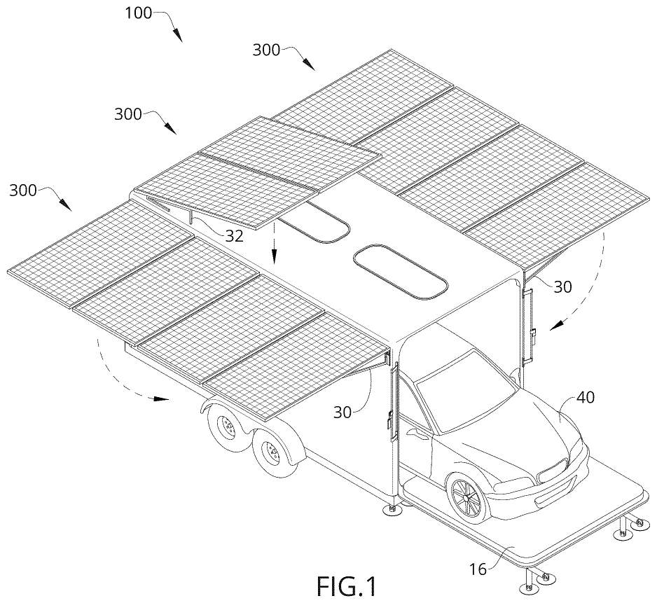

As discussed herein, and as seen by way of example in FIGS. 1-3 hereto, in a preferred embodiment the present invention comprises the following primary components.

A cargo trailer (100) is equipped with multiple solar panel brackets (300).

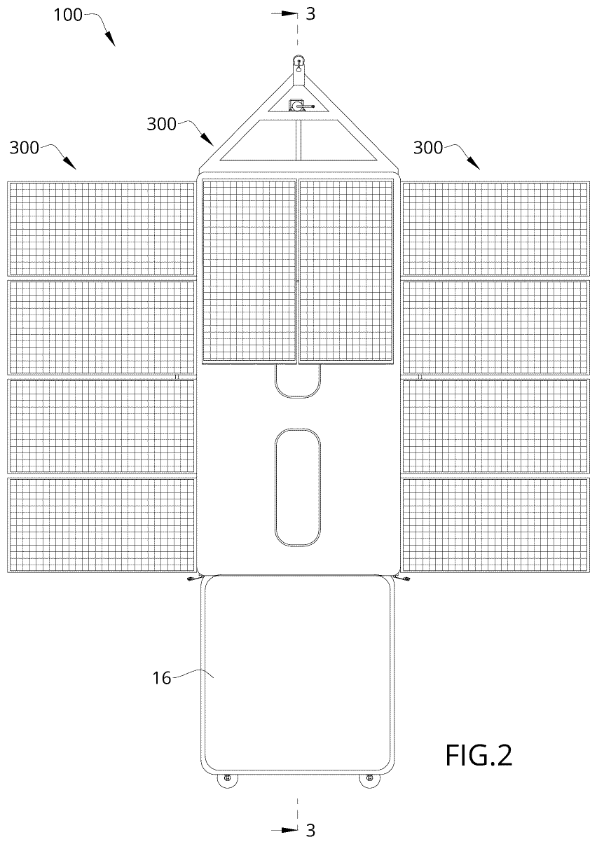

In a preferred embodiment, as shown in FIGS. 1 and 2, there are sets of solar panels (300). Two sets are mounted on the sides of the trailer using side brackets (300), another set is mounted on the top of the trailer, and a third set is positioned at the front of the trailer.

The side solar panels can fold up along the sides of the trailer and can also be adjusted to extend substantially perpendicular to the trailer's sides, as illustrated in FIG. 1. The front solar panel (300) can be folded up along the front of the trailer, perpendicular to the trailer (100), and can also be tilted upward as needed. Trailer 100 also comprises a ramp 16 that can be used to load a vehicle 40 inside the trailer.

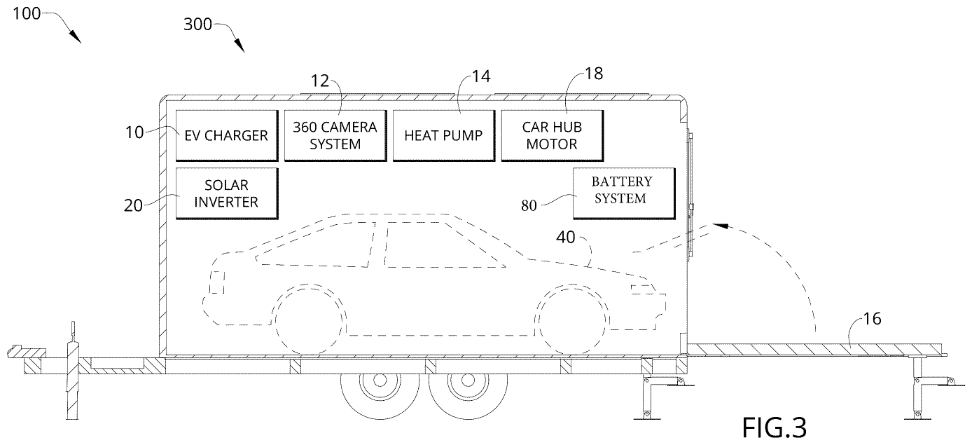

As seen by way of example in FIG. 3, the trailer also comprises an EV charger 10 and solar inverted 20 and battery system 80. Trailer 100 can also comprise a camera system 12, a heat pump 14 and a car hub motor 18. FIG. 3 also shows vehicle 40 inside the trailer and shows how ramp 16 can be lifted into a closed position once the vehicle is inside the trailer.

Constructed as such, trailer 100 of the present invention has the ability to produce power during the day via solar panels 300 in order to charge an electric car 40 during the night with a built-in solar inverter 20 and electric car charger 10. The 360-degree camera system 12 can be accessed remotely for security, and the heat pump 14 and car hub motor provide additional functionality. A battery system could also be included to store the power generated. Additionally, trailer 100 of the present invention can also be used as a backup power source.

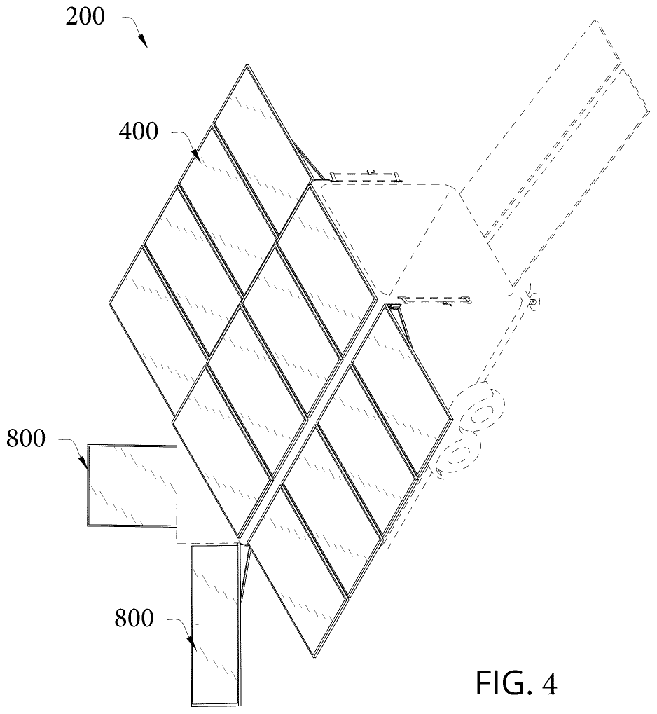

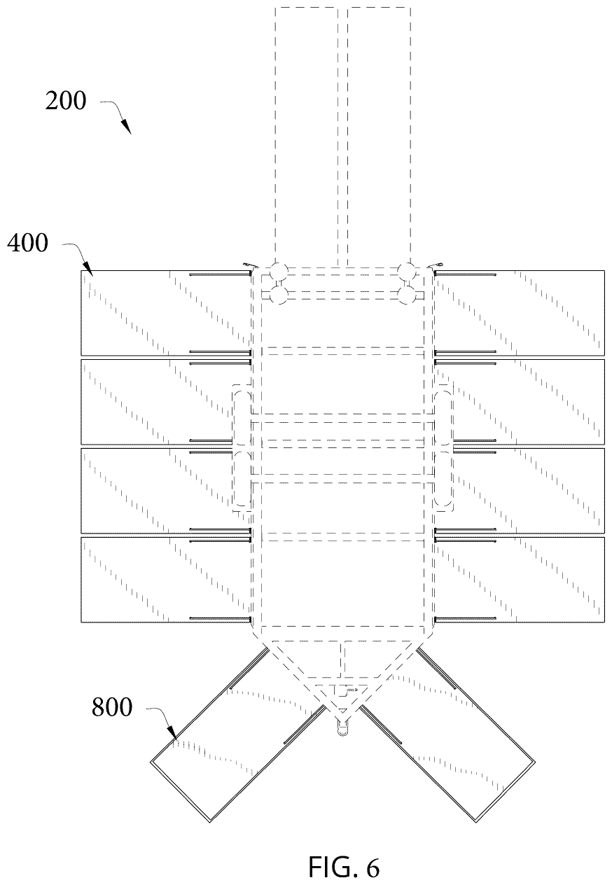

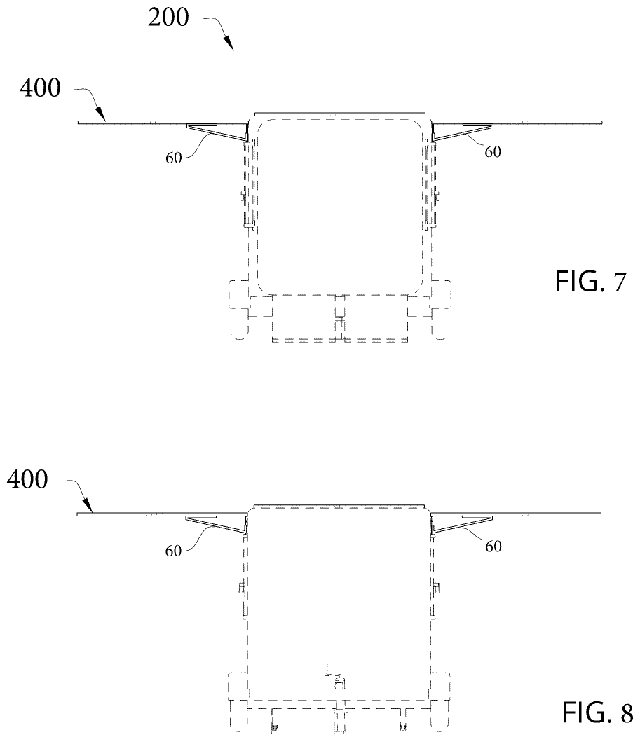

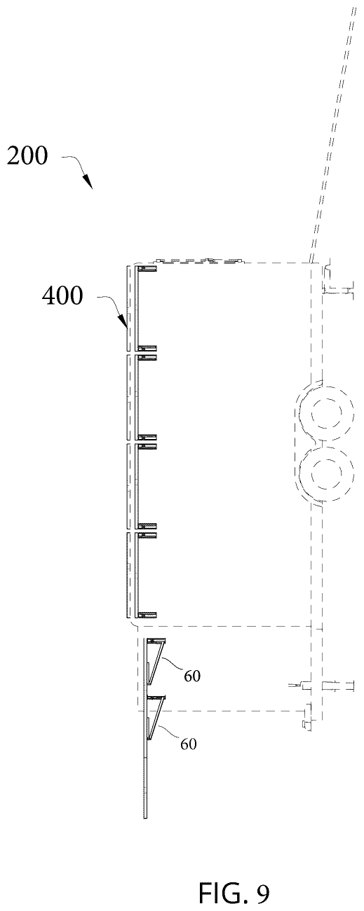

FIGS. 4-9 depict an alternative preferred embodiment the present invention, comprising a cargo trailer (200) equipped with multiple solar panels (400) mounted on the sides of the trailer, the top of the trailer, and a set of solar panels (800) positioned at the front of the trailer.

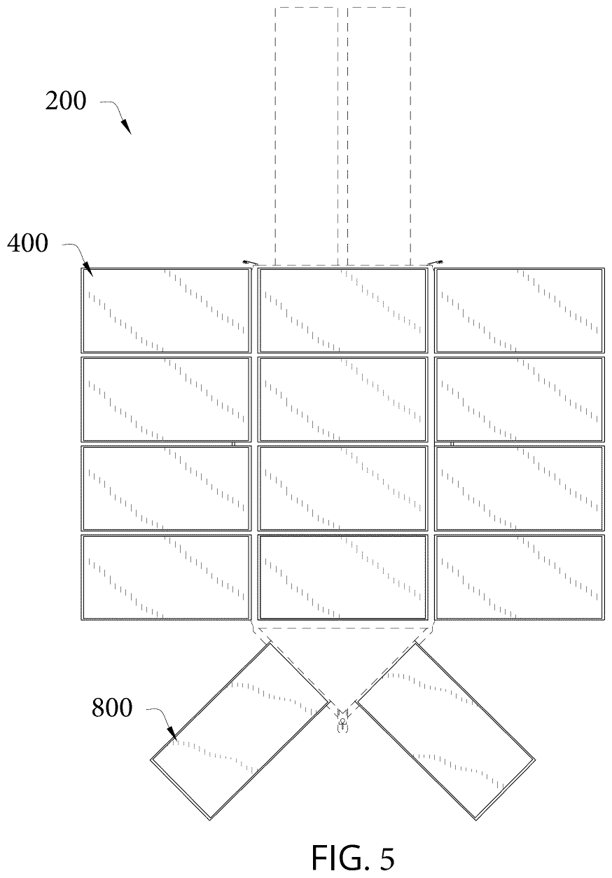

The side solar panels can fold up along the sides of the trailer and can also be adjusted to extend substantially perpendicular to the trailer's sides, as illustrated by way of example in FIG. 4. The front solar panels (800) can be extended at an angle to the trailer, as seen by way of example in FIG. 5. Trailer 200 also comprises a ramp 16 that can be used to load a vehicle inside the trailer.

Trailer 200 can also comprise an EV charger 10 and solar inverted 20 and battery system 80, a camera system 12, a heat pump 14 and a car hub motor 18 as depicted in trailer 100.

Constructed as such, trailer 200 of the present invention has the ability to produce power during the day via solar panels 400/800 in order to charge an electric car 40 during the night with a built-in solar inverter 20 and electric car charger 10. A 360-degree camera system 12 can be accessed remotely for security, and the heat pump 14 and car hub motor provide additional functionality. A battery system could also be included to store the power generated. Additionally, trailer 200 of the present invention can also be used as a backup power source

### Solar-Powered Trailer

The solar-powered trailer (100/200) of the present invention is designed to generate and store renewable energy using an integrated system of solar panels and a built-in battery. This trailer is ideal for powering equipment, providing energy in remote locations, or supporting sustainable operations.

In a preferred embodiment, as shown in FIGS. 1-9, the trailer is equipped with multiple sets of solar panels (300/400/800):
1. Side Panels: Two sets of solar panels can be mounted on either side of the trailer using adjustable side brackets (300). These panels can fold up flush against the sides for transportation and can be extended to a perpendicular position to maximize sunlight absorption.
2. Top Panel: A third set of solar panels is positioned on the roof of the trailer to harness direct sunlight throughout the day.
3. Front Panels: A fourth set of solar panels is mounted at the front of the trailer, capable of folding up perpendicular to the trailer or tilting upward for additional energy capture.

### Energy Storage:

The trailer incorporates a built-in battery system 80 that stores energy generated by the solar panels during the day. This stored energy can be used to power various applications, including lighting, charging electronic devices, running appliances, or even supporting external equipment in off-grid environments.

### Portability and Efficiency:

The solar panels are designed to be lightweight and durable, ensuring the trailer remains easy to transport while providing maximum energy efficiency. The folding and tilting mechanisms allow for optimized solar energy capture regardless of the trailer's position.

### Applications:

Emergency or disaster relief
Mobile workstations
Event Trailer; Movie trailer
Off-grid camping

This solar-powered trailer offers an eco-friendly and practical solution for mobile energy needs.

### Solar-Powered Trailers for Emergency or Disaster Relief

Solar-powered trailers provide a reliable, sustainable energy solution during emergencies or disasters. Equipped with solar panels and a built-in battery system, they offer power for lighting, communication devices, medical equipment, and other essential operations in off-grid or compromised areas. Their portability and eco-friendly design make them ideal for rapid deployment in relief efforts, reducing reliance on fuel-based generators.

### Solar-Powered Trailers for Mobile Workstations

Solar-powered trailers provide contractors with a reliable, off-grid energy source to power tools, equipment, and devices at job sites. Equipped with solar panels and a built-in battery system, these trailers ensure continuous power supply for lights, charging stations, and other workstation needs. Compact, portable, and eco-friendly, they enhance productivity while reducing dependence on traditional power sources.

Solar-Powered Trailers for Event; Movie Trailers Solar-powered trailers equipped with a built-in side LED display screen are perfect for showcasing movie trailers and promotions at events. The solar panels and integrated battery system provide a reliable, eco-friendly power source, ensuring uninterrupted playback and lighting. Portable and self-sufficient, these trailers offer a sustainable solution for captivating audiences anywhere.

### Solar-Powered Trailers for Short and Long-Term Camping

Solar-powered trailers offer a sustainable and off-grid energy solution for both short and long-term camping. With built-in solar panels and a battery system, these trailers provide power for lights, devices, and small appliances, ensuring a comfortable and eco-friendly camping experience. Ideal for remote locations, they allow campers to enjoy modern conveniences while minimizing environmental impact.

It should be understood, of course, that the foregoing relates to exemplary embodiments of the invention and that modifications may be made without departing from the spirit and scope of the invention as set forth in the following claims.

What is claimed is:

1. A power producing trailer comprising:
a first solar panel pivotably connected to a first side of the trailer;
a second solar panel pivotably connected to a second side of the trailer;
a third solar panel pivotably connected to a top side of the trailer;
a fourth solar panel pivotably connected to the front side of the trailer;
the first, second, third and fourth solar panels being electrically connected to a solar inverter, an electric vehicle charger, and a battery system designed to store energy generated by the solar panels;
the trailer further comprising a ramp to load an electric vehicle inside the trailer, the electric vehicle adapted to accept an electrical connection from the vehicle charger;
wherein the solar panels generate electricity to charge the electric vehicle.

2. The power producing trailer of claim 1, wherein the first solar panel is connected to the trailer via a first side bracket, and wherein the second solar panel is connected to the trailer via a second side bracket, and wherein the top solar panel is connected to the top of the trailer via a top bracket.

3. The power producing trailer of claim 1, wherein the first and second solar panels can be pivoted from a substantially vertical position to a substantially horizontal position.

4. The power producing trailer of claim 1, wherein the third solar panel can be pivoted upward from a substantially horizontal position.

5. The power producing trailer of claim 1, further comprising a camera system.

6. The power producing trailer of claim 1, further comprising a heat pump.

7. The power producing trailer of claim 1, further comprising a car hub motor.

8. A power producing trailer, comprising:
a trailer enclosure having an interior configured to receive an electric vehicle via a loading ramp;
a plurality of solar panels configured for both compact storage and optimized solar energy absorption when deployed, the plurality of solar panels including:
a first solar panel pivotably connected to a first side of the trailer;
a second solar panel pivotably connected to a second side of the trailer;
a third solar panel pivotably connected to a top side of the trailer; and
a fourth solar panel pivotably connected to a front side of the trailer;
an electrical energy system comprising a solar inverter, an electric vehicle charger, and a battery system, the plurality of solar panels being electrically connected to the electrical energy system to generate, convert, and store electrical energy for charging the electric vehicle while the vehicle is loaded in the trailer;
a control assembly configured to coordinate the deployment of the solar panels and the operation of the electrical energy system such that solar energy generated during a daytime operating period is stored and subsequently utilized to charge the electric vehicle during a nighttime operating period, the trailer further configured to function as a portable backup power source.

9. The power producing trailer of claim 8, wherein the trailer enclosure is constructed from lightweight, durable materials selected from the group consisting of aluminum and composite materials, to enhance portability and durability.

10. The power producing trailer of claim 9, wherein the interior of the trailer enclosure includes adjustable supports or securing mechanisms configured to stabilize the electric vehicle during transport.
